(19) United States
(12) Patent Application Publication
(10) Pub. No.: US 2017/0231858 A1
(43) Pub. Date: Aug. 17, 2017

(54) LIMB TREATMENT DEVICE AND METHOD FOR TREATMENT OF VASCULAR AND/OR NEUROPATHIC DISORDERS

(71) Applicant: Ronald Dale Carter, SR., Lynn Haven, FL (US)

(72) Inventor: Ronald Dale Carter, SR., Lynn Haven, FL (US)

(21) Appl. No.: 15/044,497

(22) Filed: Feb. 16, 2016

(51) Int. Cl. A61H 7/00

(52) U.S. Cl. CPC A61H 7/001; A61H 2201/0207; A61H 2205/106; A61H 2201/1253

(57) ABSTRACT

A medical treatment device and method provide relief from symptoms of peripheral neuropathy and/or vascular dysfunction. The device provides pressure along an inner surface of a human limb of a user, so that at least a portion of the pressure is derived from the weight of the user seated atop the device, and includes a frame for providing support of the device on a floor and one or more curved extensions extending above a center of the frame and downward toward the floor and configured to contact the inner surface of the limb of the user so that weight of the limb supplies at least some of the pressure. The treatment method includes seating a patient atop the device and maintaining the pressure for a treatment interval to provide relief from the symptoms of the peripheral neuropathy and/or vascular dysfunction.

### BACKGROUND OF THE INVENTION

1. Field of the Invention

The present invention relates generally to medical equipment for applying physical pressure to human limbs, and more particularly, to a device and method for applying pressure to the inside surfaces of legs to alleviate vascular disorders and/or peripheral neuropathy .

2. Description of the Related Art

Treatment for peripheral neuropathy in the medical environment is typically pharmaceutical, although treatment of peripheral neuropathy due to vascular disorders, such as peripheral vascular disease, may recommend the use of pressure-applying devices such as compression stockings. Alternative medicinal treatments for peripheral neuropathy include acupuncture and herbal remedies. Pharmaceutical treatment runs the risk of side-effects, tolerance building and the possibility of ineffectiveness, while alternative treatments may or may not be effective or may have only placebo effects.

Therefore, it would be desirable to have a treatment method and treatment device for treating peripheral neuropathy and/or vascular disorders that is effective and non-pharmaceutical.

### SUMMARY OF THE INVENTION

Treatment for peripheral neuropathy and/or vascular disorders is provided in a medical treatment device and treatment method. The treatment device and method provide pressure along an inner surface of a human limb of a user, where at least a portion of the pressure is derived from the weight of the user seated atop the device. The treatment device includes a frame for providing support of the device on a floor and one or more curved extensions extending above the frame and downward toward the floor and configured to contact the inner surface of the limb of the user so that at least the weight of the limb of the user supplies at least some of the pressure.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1 is a side view showing an example of a medical treatment device as disclosed herein in use for treating a patient 4.

FIGS. 2A-2C are an isometric view, a top view and a side view, respectively, of an alternative example of a medical treatment device as disclosed herein.

FIG. 3 is an isometric view showing details of the medical treatment device of FIG. 1.

FIG. 4 is a side view showing further details of the medical treatment device of FIG. 1.

FIGS. 5A-5C are an isometric view, a bottom view and a side view, respectively, showing further details of the medical treatment device of FIG. 1.

FIG. 6 is a side view showing another alternative medical treatment device as disclosed herein.

### DESCRIPTION OF ILLUSTRATIVE EMBODIMENT

The present invention includes devices and methods for treating peripheral neuropathy and/or peripheral vascular disease. The device uses the patient's own weight to apply substantially continuous pressure along an inner surface of a patient's limb. A seat is provided having extensions that curve downward applying pressure to the inner surfaces of the patient's legs. The extensions may be adjustable to control the pressure and for easier mounting onto the device.

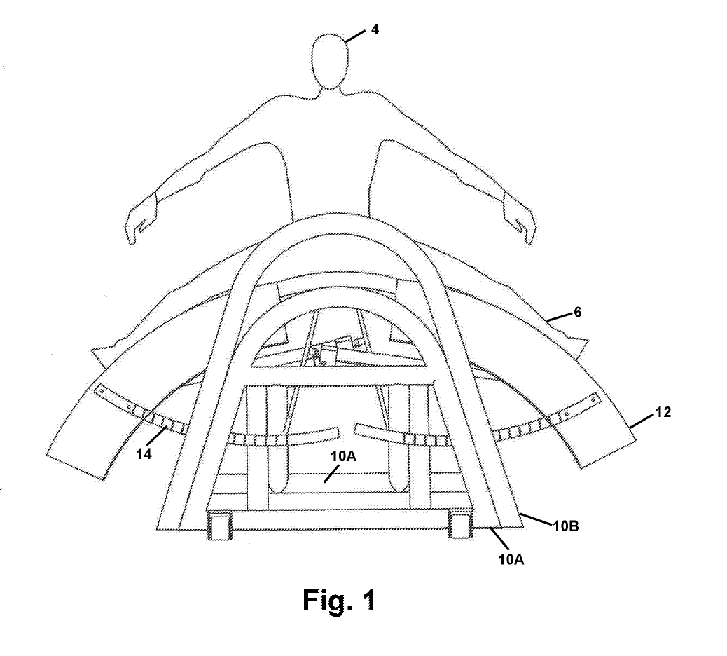

Referring now to FIG. 1, a medical device performing a treatment method is shown in an illustrative example. A patient 4 is seated atop a device that includes a frame formed by frame members 10A and 10B, and which includes a pair of extensions 12 that extend from the top of the device toward the floor. Frame members 10A, 10B support the device above the floor, and extensions 12 are rotatable to control the degree of pressure applied to inner surfaces of legs 6 of patient 4, i.e., the surfaces of legs 6 that make contact with the device. The weight of patient 4 provides at least some of the pressure applied to the inner surfaces of legs 6, but by rotating extensions 12 upward, the pressure can be increased, and by rotating extensions 12 downward, the pressure is decreased. A pair of protractor scales 14 can be provided for recording purposes, as the degree of flexibility of patient 4 will generally increase with treatment, and the angle of extensions 12, which is shown by the alignment of marks on protractor scales 14 with frame member 10B or 10A, provides an indication of the degree of pressure being applied for a given patient. Treatment with the device is provided by seating patient 4 atop the device for a treatment interval, which provides relief of symptoms associated with peripheral neuropathy and/or vascular dysfunction.

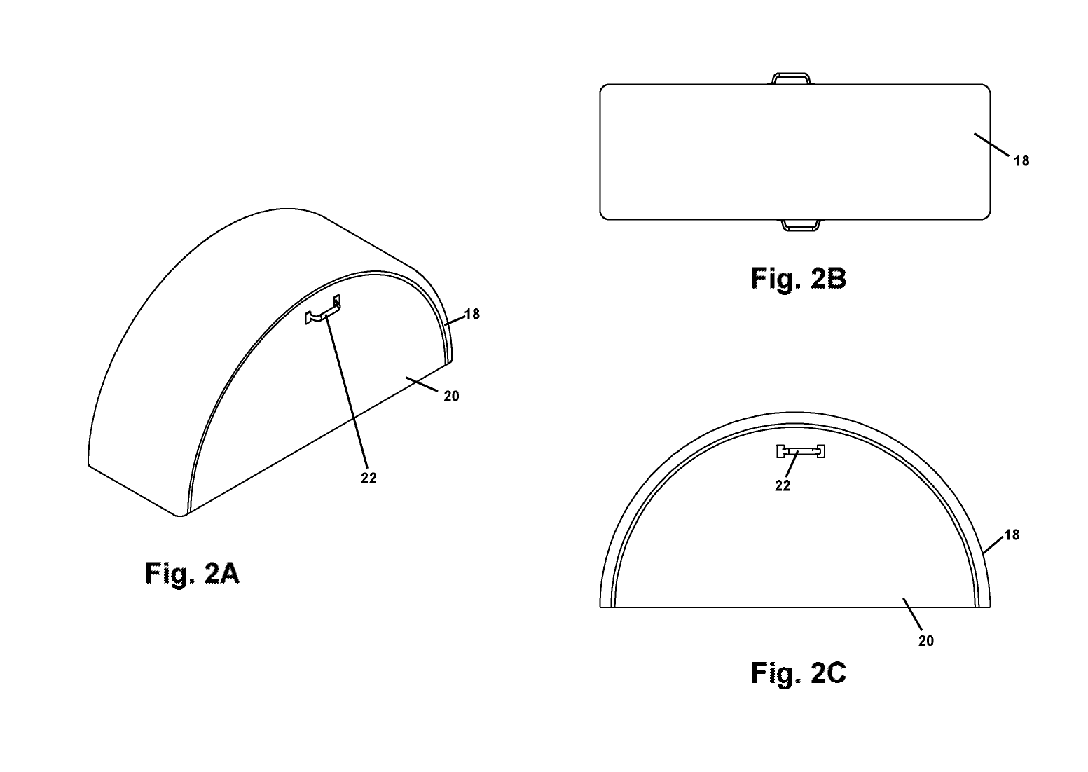

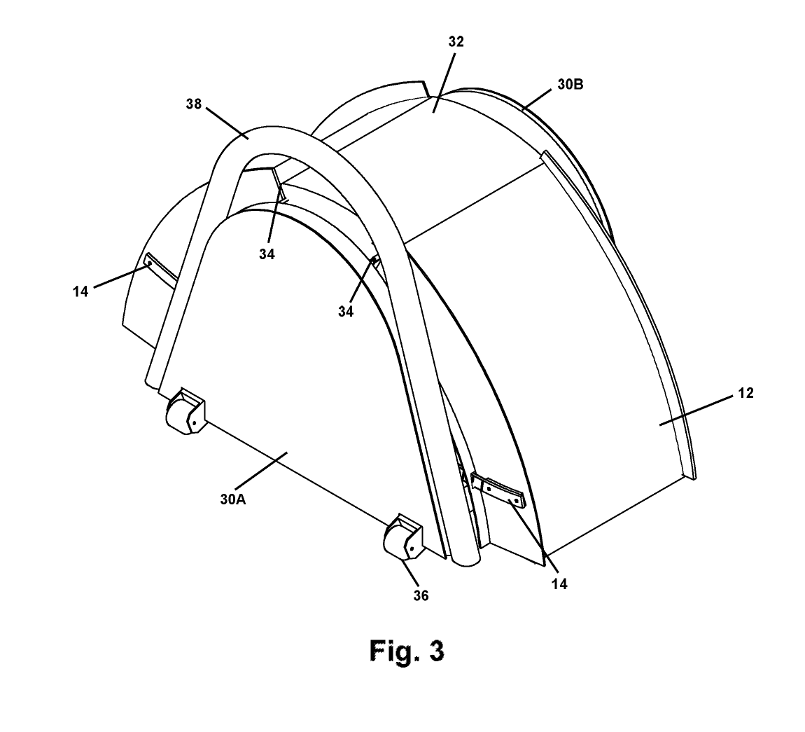

Referring now to FIGS. 2A-2C, an alternative embodiment of the medical treatment device disclosed herein is shown in an isometric view, a top view and a side view, respectively. A solid base 20, which is generally hollow and may be molded from plastic, or fabricated from wood and/or metal components, provides support for a pad 18 that extends downward along the top of the device, so that an extension in each direction will support and apply pressure to a patient's legs due to the weight of the patient atop the device. Handles 22 are provided for moving the device. while the medical treatment device shown in FIGS. 2A-2C does not include the adjustability provided by the medical treatment device of FIG. 1, similar results can be obtained, and some adjustment can be provided by increasing or decreasing an amount of padding provided atop the device.

Referring now to FIG. 3, additional details of the medical treatment device disclosed in FIG. 1 is shown in an isometric view. A curved seat 32 is provided atop the device and is affixed to frame members 10A, 10B for support, which may be provided by a welding tube stock from which frame members 10A, 10B are formed to a metal plate, which is bent to form curved seat 32. For example, frame members 10A,10B and other components may be formed from aluminum and assembled by welding. Other materials and techniques having sufficient strength may alternatively be used. Extensions 12 are attached to curved seat 32 by respective hinges 34. Frame member 10B extends above curved seat 32 and frame member 10A to provide a handle 38, which in combination with a pair of rollers 36 attached to a front one of frame members 10A, 10B provides operation in the manner of a hand truck, for rolling the medical treatment device from location to location. A front cover 30A and a back cover 30B provide for enclosing moving parts of the device for safety, as some embodiments are motorized as will be described below, and for ease of maintaining sanitation, etc.

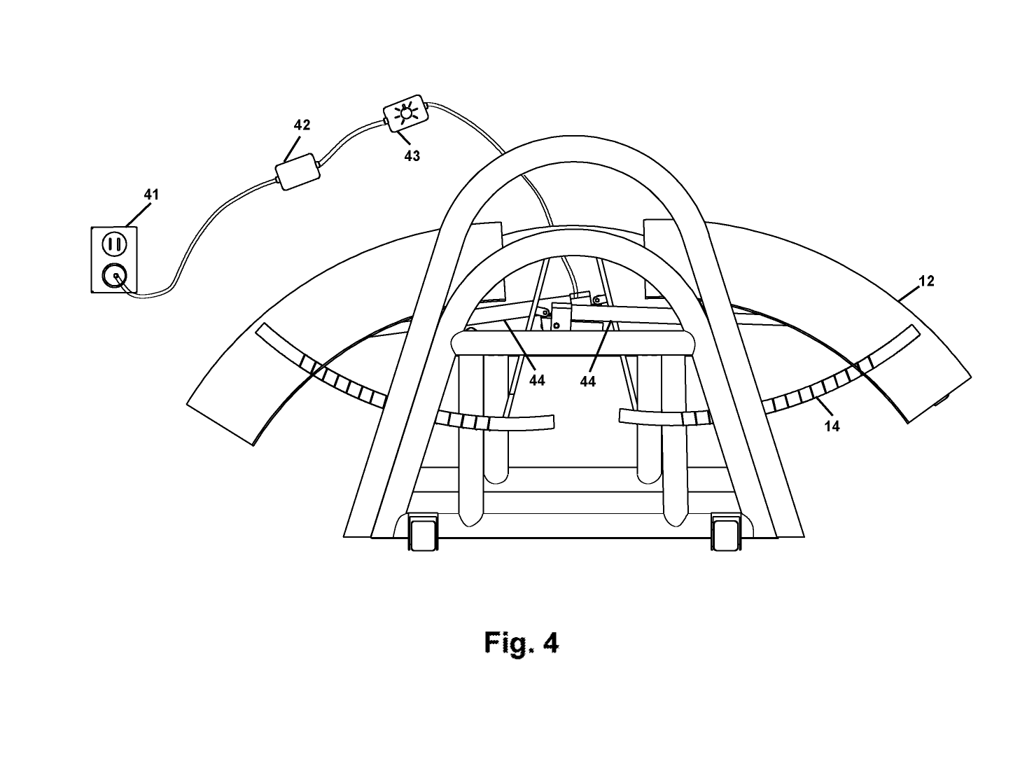

Referring now to FIG. 4, further details of the medical treatment device shown in FIGS. 1 and 3 are illustrated. A pair of motors 44, which are linear actuators, are controlled by a hand-held controller 43 provided power from a motor control power supply 42 and powered by an AC receptacle 41. Motors 44 can be activated in forward or reverse directions to raise and lower extensions 12, and the position of extensions 12 can be noted by protractor scales 14. Hand-held controller 43 may alternatively be provided by a wireless remote control that communicates with motor control power supply 42 to control motors 44.

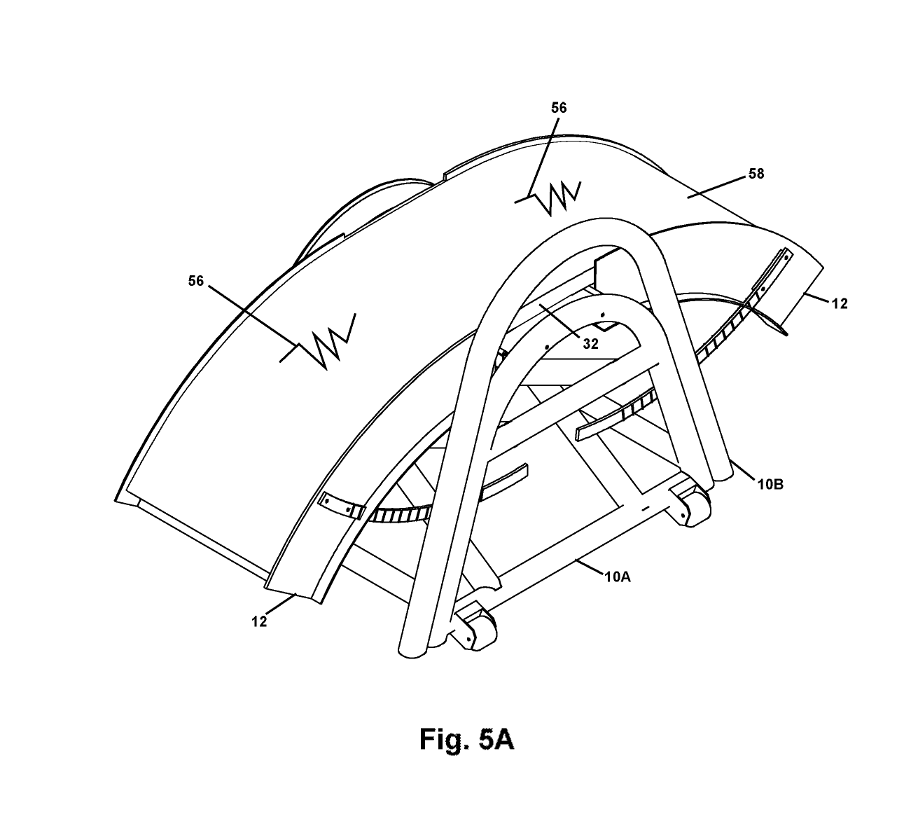

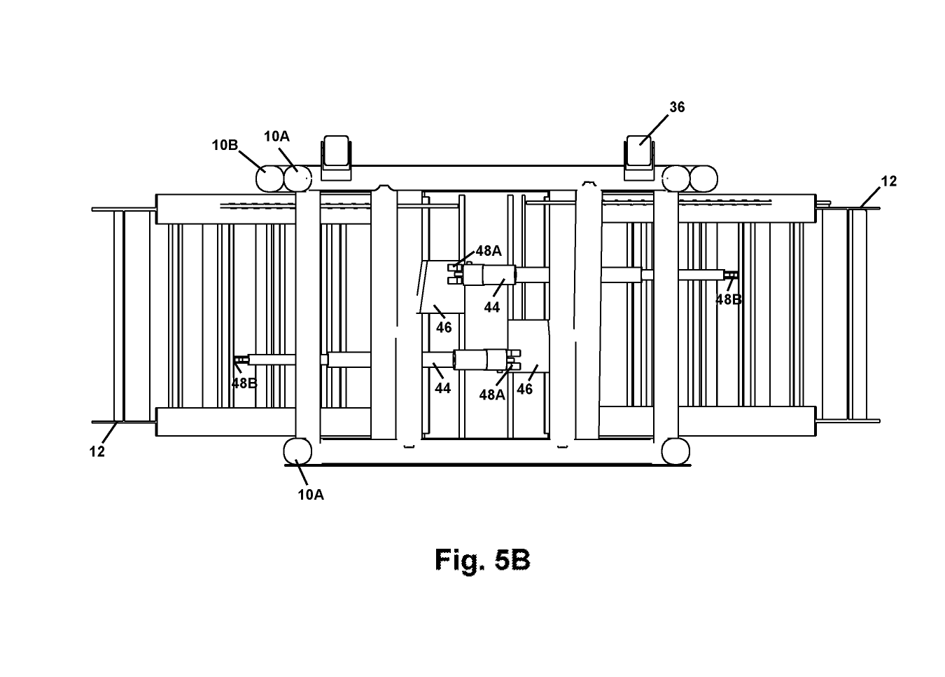

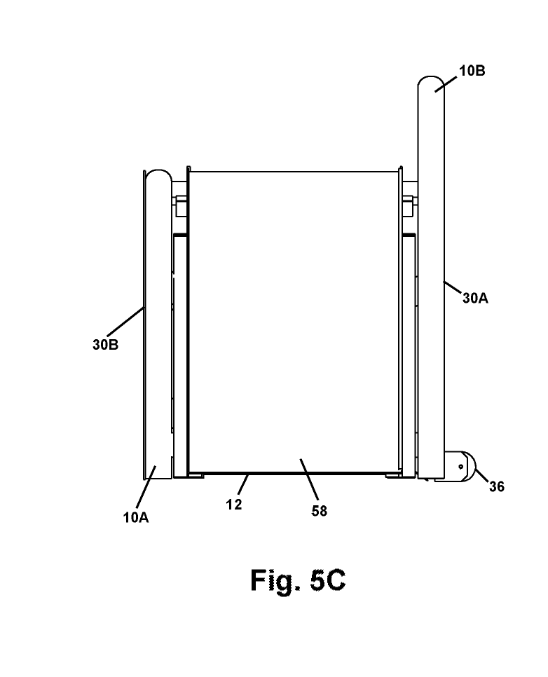

Referring now to FIGS. 5A-5C, further details of the medical treatment device shown in FIGS. 1 and 3-4 are illustrated in an isometric view, a bottom view and a side view, respectively. FIG. 5A shows that a pad 58 is provided atop curved seat 32 and extensions 12, to provide for comfortable seating atop the device. In some embodiments. pad 58 contains heating elements 56 that can be controlled by hand-held controller 43 or a secondary controller, or which may operate at a fixed temperature to aid in increasing flexibility and circulation in a patient seated atop the device. In FIG. 5B, the position of motors 44 is seen, and in particular the front-to-back displacement between motors 44 that prevents interference between the extension arms of motors 44 during operation. Motors 44 are mounted via rotating pins or other rotating mounts 48A to motor mounts 46 welded to frame members 10A and at opposing ends are affixed to rotating mounts 48B welded to extensions 12. FIG. 5C is a side view showing further details of pad 58 along with side views of frame members 10A, 10B, relative to the sides of extensions 12.

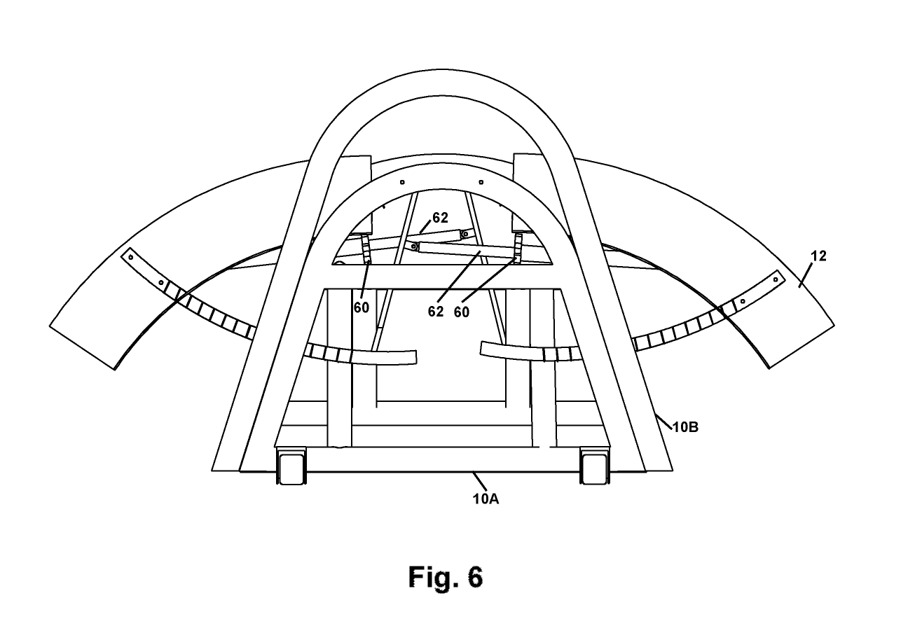

Referring now to FIG. 6, another alternative embodiment of the medical treatment device is shown. The medical treatment device of FIG. 6 is similar to the medical treatment device of FIGS. 1 and 3, and so only differences between them are described below. Instead of motors 44, a pair of turnbuckle-operated shafts 62 equipped with turnbuckles 60 are provided for adjusting each of extensions 12. Front cover 30A may need to be omitted, or may be made openable/removable to provide for adjustment of turnbuckles 60 to raise and lower extensions.

While the invention has been particularly shown and described with reference to the preferred embodiment thereof, it will be understood by those skilled in the art that the foregoing and other changes in form, and details may be made therein without departing from the spirit and scope of the invention.

1. A medical treatment device for providing pressure along an inner surface of a human limb of a user, wherein at least a portion of the pressure is derived from the weight of the user seated atop the device, the device comprising:
a frame for providing support of the device on a floor; and
one or more curved extensions extending above a center of the frame and downward toward the floor and configured to contact the inner surface of the limb, whereby a weight of at least the limb supplies the at least the portion of the pressure .

2. The medical treatment device of claim 1, wherein the one or more curved extensions comprises a single semi-cylindrical surface extending downward toward the floor toward each side of the user, wherein the frame provides a base for support of the semi-cylindrical surface.

3. The medical treatment device of claim 1, wherein the one or more curved extensions comprises a pair of extensions attached to the frame by a corresponding pair of hinges, wherein the curved extensions are rotatable to vary the pressure applied to inner surfaces of legs of the user.

4. The medical treatment device of claim 3, further comprising a seat disposed between the pair of hinges, wherein when the user is seated atop the seat, the seat provides partial support of the user, and wherein the pair of extensions supplies the pressure.

5. The medical treatment device of claim 4, wherein the seat has a curved profile to reduce discontinuities between the seat and the attachment between the curved extensions at the hinges.

6. The medical treatment device of claim 4, wherein the frame is formed from two tubular members and shaped to have a curved upper portion substantially parallel to the floor and extending downward at each end of the curved upper portion to form a pair of legs at opposing ends of each of the tubular members, wherein the seat is fastened to the frame proximate the curved upper portion of the tubular members, and wherein the pair of extensions are attached to the seat by the hinges proximate the transition between the curved portions of the tubular members and the upper ends of the pair of legs formed by the tubular members.

7. The medical treatment device of claim 6, further comprising:
a third tubular member shaped to extend along a given one of the pair of the two tubular members, wherein the third tubular member has a curved portion extending above the given tubular member to provide a handle; and
a pair of rollers affixed to a bottom of the frame beneath the third tubular member, wherein the medical treatment device is movable by rotating the handle to tilt the frame move the center of gravity of the medical treatment device substantially over the rollers, whereby the medical treatment device is movable by rolling the medical treatment device along the floor on the rollers.

8. The medical treatment device of claim 3, further comprising a mechanism for spreading the pair of extensions away from the frame and retracting the pair of extensions toward the frame, wherein operation of the mechanism causes the extensions to rotate about the hinges.

9. The medical treatment device of claim 8, wherein the mechanism includes at least one motor for extending and retracting the extensions with respect to the frame.

10. The medical treatment device of claim 3, further comprising at least one protractor scale disposed on either the extensions or the frame for providing an indication of a degree to which the extensions are rotated with respect to the frame about the hinges.

11. The medical treatment device of claim 1 further comprising one or more pads mounted above the one or more curved extensions, wherein the pad is compressible with the weight of the user.

12. The medical treatment device of claim 11, further comprising one or more heating elements disposed within the one or more pads to apply heat to the limbs of the user.

13. A medical treatment device for providing pressure along an inner surface of a human limb of a user, wherein at least a portion of the pressure is derived from the weight of the user seated atop the device, the device comprising:
a curved seat;
a frame for providing support of the device on a floor and formed from two tubular members and shaped to have a curved upper portion substantially parallel to the floor and extending downward at each end of the curved upper portion to form a pair of legs at opposing ends of each of the tubular members, wherein the seat is fastened to the frame proximate the curved upper portion of the tubular members;
a pair of extensions attached to ends of the seat by hinges proximate the transition between the curved portions of the tubular members and the upper ends of the pair of legs formed by the tubular members, wherein the curved extensions are rotatable to vary the pressure applied to inner surfaces of legs of the user; and
a mechanism for spreading the pair of extensions away from the frame and retracting the pair of extensions toward the frame, wherein operation of the mechanism causes the extensions to rotate about the hinges.

14. A method of treatment for peripheral neuropathy or vascular dysfunction, the method comprising:
seating a patient atop a device for supplying pressure to inner surfaces of a limb of the patient; and
maintaining the pressure for a treatment interval, whereby the seating and maintaining provide relief from the symptoms of the peripheral neuropathy or vascular dysfunction.

15. The method of claim 14, wherein the seating seats the patient atop a device including a frame for providing support of the device on a floor and one or more curved extensions extending above a center of the frame and downward toward the floor and configured to contact the inner surface of legs of the patient, whereby a weight of at least the legs of the patient supplies the at least the portion of the pressure.

16. The method of claim 15, wherein the one or more curved extensions comprises a pair of extensions attached to the frame by a corresponding pair of hinges, wherein the method further comprises rotating the curved extensions to vary the pressure applied to the inner surfaces of the legs of the patient.

17. The method of claim 16, further comprising a seat disposed between the pair of hinges, wherein the seating seats the patient atop the seat and the seat provides partial support of the patient, and wherein the pair of extensions supplies the pressure.

18. The method of claim 16, further comprising spreading the pair of extensions away from the frame and retracting the pair of extensions toward the frame using a mechanism, wherein operation of the mechanism causes the extensions to rotate about the hinges.

19. The method of claim 18, wherein the mechanism includes at least one motor for extending and retracting the extensions with respect to the frame, and wherein the spreading and retracting are performed by activating the motor.

20. The method of claim 14, further comprising applying heat to the limb of the patient using one or more heating elements disposed within one or more pads provided atop device to apply heat to the limb of the user.
